(19) United States
(12) Patent Application Publication
(10) Pub. No.: US 2023/0168096 A1
(43) Pub. Date: Jun. 1, 2023

(54) Method For Determining At Least One Itinerary Between At Least Two Points According To A Personalized Exposome And Associated Application

(71) Applicant: Meersens, Lyon (FR)

(72) Inventors: Emilie CALABRE, Lyon (FR); Morane REY-HUET, Lyon (FR); Louis STOCKREISSER, Lyon (FR)

(73) Assignee: Meersens, Lyon (FR)

(21) Appl. No.: 17/919,922

(22) PCT Filed: Apr. 19, 2021
(86) PCT No.: PCT/FR2021/050685

§ 371 Date: Oct. 19, 2022

(30) Foreign Application Priority Data
Apr. 20, 2020 (FR) 2003941

(51) Int. Cl. G01C 21/34; G01C 21/36

(52) U.S. Cl. CPC G01C 21/3461; G01C 21/3617

(57) ABSTRACT

A method for determining a route between two points interconnected by arcs, in which the weight of each arc is calculated by the following steps: obtaining a plurality of environmental quality indicators for a plurality of different pollutants, each environmental quality indicator being calculated on the basis of an estimate of each pollutant, which estimate is standardized by using a reference risk scale; determining at least one risk factor associated with each pollutant for a specific user; calculating an overall risk factor corresponding to the maximum of a product between each environmental quality indicator and each risk factor; and calculating the weight by multiplying an estimated travel time to cross the arc by the overall risk factor.

### TECHNICAL FIELD

The invention relates to a method for determining of at least one route of least exposure, i.e., a route limiting the health risks associated with the presence of environmental pollutants for a known and determined health profile and the user's exposome. This route is calculated taking into account the time factor, to propose the path of least exposure within an “acceptable” time period in relation to the shortest path.

In the context of the invention, the exposome corresponds to all the exposures to non-genetic environmental factors that a human organism is subjected to from their conception to the end of their life.

The invention may be implemented in a remote server, mobile application or on-board computer of a motor vehicle. In addition, the application may also be used to propose a route either on foot, or by bicycle, car, bus or any other means of transport. The application may also propose a deferred departure if the travel time or estimated exposures were limited in event of a delayed departure.

### PRIOR ART

The health of a human being depends on their genetic makeup. Complementing the effect of the genome, the exposome explains the external and environmental factors impacting an individuals health, from their conception to the end of their life.

By analysing an individuals exposure over time, it is possible to design predictive and personalised prevention methods with a view to improving human health.

The present invention aims to use these prevention methods to improve the health of users by limiting the risk factors which their organisms are subjected to during their movements.

Thus, the aim of the invention is to recommend at least one route of movement between two points which limits the exposure to the environmental pollutants which a particular user is sensitive to, taking into account the time factor.

However, there are a large number of diverse and varied pollutants which may be grouped into different categories (airborne pollutants, noise pollution, solar pollution, etc.). For each category, a user may be more or less sensitive to one or a plurality of the pollutants in that category, which means that it is complex to develop a method that takes these diverse variables into account.

To inform users of a network, solutions are currently available for indicating the average exposure to airborne pollutants measured on a route. For example, the AirParif® and Itiner'Air® applications allow a user to indicate the route that they intend to take, by entering the day, departure time and mode of transport, to obtain an average exposure rate to airborne pollutants. With this information, the user may defer their route if they wish to limit their exposure to certain airborne pollutants.

To present this information on exposure to airborne pollutants, these applications use maps of environmental pollutants, such as nitrogen dioxide (NO₂), ozone (O₃), and fine particles (PM 2.5 and PM 10). These data of pollutants on specific areas are obtained by means of sensors present in towns and cities.

However, these applications make it possible to obtain only one piece of information on pollutants that are diffused into the atmosphere, but do not make it possible to account for other types of pollution, such as solar pollution or noise pollution.

In addition, these applications do not take into account the particular profile of the user, thus making them too generic when considered from a perspective of personalised prevention.

In other fields, there are applications which make it possible to recommend a route between two points by using a plurality of factors other than merely searching for the shortest travel time.

For example, the GeoVélo® application provides users with the option of cycling preferentially on sections which bicycle paths are provided for.

To this end, the GeoVélo® application uses a Dijkstra algorithm in which all the routes of the network are represented in the form of a point cloud with a set of arcs interconnecting these points. The points correspond to the intersections between the roads and the arcs represent the set of possible routes to traverse between two points.

Instead of using the conventional Dijkstra algorithm intended to minimise the travel time between two points by taking into account the time to traverse each arc, the GeoVélo® application proposes to modify the weight of each arc according to the presence or absence of bicycle paths.

Thus, the arcs which no bicycle path is provided for, have a weight greater than the arcs of the same length which a bicycle path is provided for on the roadway.

It follows that the Dijkstra algorithm calculates a route with a compromise between the travel time and the presence of bicycle paths on all or a portion of the route.

Searching for a compromise while arranging a route is quite complex when two different factors are used, because it is necessary to correctly modify the weight of each arc without causing an excessive diversion when the user is able to travel a small part of the route without using any bicycle paths.

Within the context of the invention, it is desirable to be able to take into account a much greater number of factors corresponding to the various environmental pollutants which may influence the user even though these environmental pollutants are of different types and may have very variable ranges of values. In fact, whereas the presence or absence of a bicycle path is a binary variable, the concentration of nitrogen dioxide or the quantity of fine particles in the air are two variables which may have a large number of different values. Moreover, these measurements are heterogeneous and it is particularly difficult to compare any concentration of nitrogen dioxide, measured in ppm, with any concentration of fine particles, measured in μg/m³. Furthermore, it is desirable to propose a route according to the risk factors specifically associated with a user, which further complicates any compromise to be obtained to determine a route.

Thus, the technical problem of the invention determining at least one route for a particular user profile by minimising the travel time between two points while limiting the influence of the environmental pollutants which the user is sensitive to.

### DISCLOSURE OF THE INVENTION

To solve this technical problem, the invention proposes to modify the weights of each arc by seeking a maximum risk factor for the user according to the readings of environmental pollutants on the arc considered, by standardising this measurement by using a reference risk scale, and by combining this standardised pollution data with the sensitivity of the user to this pollutant.

Thus, the weight of each arc is determined according to this maximum risk factor and an estimated travel time for traversing this arc.

It follows that the weights of all of the arcs of a point cloud may be modified over time according to the presence or absence of pollutants on these arcs and of the specific risk linked to the user relating the presence of this pollutant. The invention thus makes it possible to recommend a route particularly suitable for preserving the health of a user and/or for the users route to meet their quality requirements.

To this end, according to a first aspect, the invention relates to a method for determining at least one route between at least two points of a point cloud interconnected by arcs, said method comprises the following steps:
identifying a set of possible paths between said at least two points by using one or a plurality of said arcs placed between said at least two points;
calculating a weight of each arc used in said possible paths;
calculating a total weight of each possible path by performing the sum of said weights of said arcs of said possible path; and
determining at least one route between said at least two points by searching for at least one path among said possible paths having a minimum total weight.

The invention is characterised in that said calculation of said weight of each arc is obtained by means of the following steps:
obtaining a plurality of environmental quality indicators of said arc for a plurality of different pollutants; each environmental quality indicator being calculated on the basis of an estimate of each pollutant on said standardised arc by using a reference risk scale;
determining at least one risk factor associated with each pollutant for a specific user;
calculating an overall risk factor corresponding to the maximum of one product between each environmental quality indicator and each risk factor; and
calculating said weight of each arc by multiplying an estimated travel time to cross said arc by using said overall risk factor calculated for said arc.

By standardising the measurements of the different pollutants that may be obtained on different arcs by using a reference risk scale, it is possible to compare these measurements with each other. Comparing the standardised measurements of pollutants is all the more relevant because it depends on the risk factor of the user for each pollutant.

Thus, the invention proposes subjecting two different treatments to the measurements of the different pollutants of each arc so that the modification of the weight of each arc be particularly adapted to the specifications or to needs of the user.

The risk factor associated with each user may be defined by the user themselves or by their attending doctor.

According to one embodiment, the determination at least one risk factor associated with each pollutant for a specific user is obtained according to a user profile and predetermined risk factors associated with each characteristic of said user profile. Thus, the user must only complete their profile and the risk factors are calculated automatically on the basis of predetermined risk factors.

According to one embodiment, the pollutants belong to different environmental pollutant categories; said step for calculating an overall risk factor being performed by calculating the maximum of a plurality of categorical risk factors; each categorical risk factor corresponding to a maximum of a product between each environmental quality indicator and each risk factor of one environmental pollutant category.

For example, if a user is very sensitive to the level of urban noise and wishes to move while limiting noise pollution, the user may indicate that the noise pollutant category is a particularly sensitive category for them, so that the weight in this category will be taken into account as a very important factor. Furthermore, a user who suffers from lupus may be particularly sensitive to ultraviolet solar radiation and may search for a route that minimises exposure to the sun.

Advantageously, the categories of environmental pollutants correspond to airborne pollutants, solar pollutants, noise pollutants, electromagnetic pollutants and/or health pollutants.

This embodiment makes it possible to effectively cover the most common types of different pollutants, which can be used to obtain reliable and distinctive measurements throughout different arcs. For example, it is possible to estimate the solar pollution of each arc on the basis of meteorological information by estimating the quantity of ultraviolet radiation undergone that the user is subjected to when using a specific arc. Noise pollution may be measured by microphones arranged on each arc so as to measure the decibel level recorded, over time, on each arc. Health pollutants may correspond to the locations of people infected by a very highly transmissive disease.

Advantageously, the airborne pollutants considered include nitrogen dioxide, sulphur dioxide, ozone, carbon monoxide, pollen and/or fine particles. These airborne pollutants may also be measured by sensors present on the arcs or be estimated on the basis of pollutant propagation models by combining meteorological information, in particular wind direction and strength, by using measurements or estimates of the presence of pollutants in areas close to the arc considered.

Searching for a maximum in the categories of pollutants prior to modifying the weights of each arc makes it possible to use an application or on-board computer, displaying the route determined by the method, also to indicate which categories of pollutants predominate for each calculated route, so that the user may decide to use a shorter route completely aware that they will be subjected to the predetermined pollutants.

For example, the route with the lowest exposure may be shown in green, whereas a secondary route may be shown in red, indicating that this route has been selected without taking into account the noise pollutant category, since a travel time saving of more than 10% of the total travel time may be obtained by removing this categorical constraint in the route search. Thus, the breakdown by pollutant category allows the user to quickly and consciously choose the time savings expected in the route in relation to the constraints which they will have to undergo while using one route or another.

According to this embodiment, said method is configured to detect, for each weight, said environmental pollutant category corresponding to the maximum of the calculated categorical risk factors, so that said at least one route may be associated with a predominant risk factor category corresponding to said maximum environmental pollutant category for the largest number of arcs of said at least one route.

Advantageously, said method is configured to determine two routes:

a first route associated with a predominant risk factor category; and
a second route calculated without taking into account said predominant risk factor category in said weights of each arc.

Other routes may also be proposed to the user by estimating the presence of the pollutants on the different arcs at a plurality of times.

For example, calculating the travel time 10, 20 and 30 minutes after the present moment means that it is possible to propose another route with a shorter travel time if the user defers their departure by a few minutes. Preferably, a subsequent route is proposed only if the travel time saving is greater than a threshold value, for example 10% of the travel time along with one immediate departure.

According to this embodiment, said method is configured to calculate one or a plurality of routes at subsequent times and, if one of the subsequent routes has an improvement in the travel time that is greater than a threshold value, to propose two routes:

a first route with an immediate departure; and
a second route with a deferred departure; said second route corresponding to the subsequent route having the greatest improvement in the travel time.

According to one embodiment, said travel time to cross said arc is estimated according to a type of a selected means of transport, a length of said arc and an average speed of said selected means of transport.

According to a second aspect, the invention relates to a smartphone application implementing a method for determining at least one route according to the first aspect of the invention.

### DESCRIPTION OF THE FIGURES

The way of implementing the invention, as well as the advantages resulting from it, will become apparent from the description of the embodiments below, in accordance with the appended figures in which:

FIG. 1 is a diagrammatic view of a network comprising a set of points interconnected by arcs;

FIG. 2 is a flowchart describing the steps for determining at least one route between two points in FIG. 1; and

FIG. 3 is a flowchart describing the steps for calculating the weight of the arcs in FIG. 1.

### DETAILED DESCRIPTION OF THE INVENTION

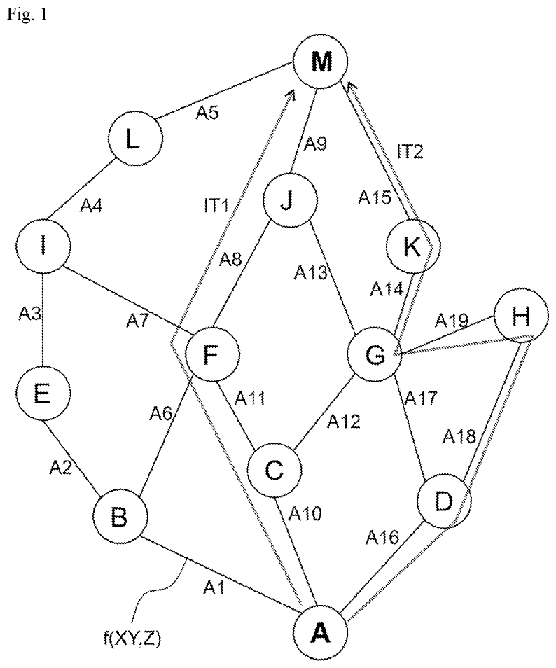

FIG. 1 illustrates a network in which the nodes of the network are represented schematically by interconnection points A to M.

In the example of a road network, the interconnection points A to M correspond to intersections between a plurality of possible routes on the road network. Of course, the invention is not limited to a road network and it may be possible to determine a route in other situations than that of a road network, for example to determine the goods movement route on an order preparation platform or to determine a route for an air flight.

In the remainder of the description, a road network will be used as an example to present the invention.

The road network is represented schematically by a point cloud A to M representing the various intersections of the network, whereas the roads arranged between two intersections are represented schematically by arcs A1-A19. For example, the first intersection A is connected by three arcs A1, A10 and A16 to three intersections B, C and D. In the same manner, intersection B is connected to intersection A by arc A1. Intersection B is also connected to intersections E and F by arcs A2 and A6.

The number of intersections A-M and of arcs A1-A19 illustrated in FIG. 1 is purely arbitrary and aims to show that to traverse a network between two intersections A and M, there are often a large number of possible routes passing through a plurality of different intersections. For example, to go from intersection A to intersection M, it is possible to use arcs A1, A2, A3, A4 and A5 or arcs A1, A6, A7, A4 and A5, or arcs A10, A12, A14 and A15. The denser the network, i.e., it has a large number of intersections A-M, the greater the number of possible routes between two distant points of the network.

The invention more particularly aims to determine a route between two points, for example A and M, by limiting the presence of pollutants that a specific user is sensitive to, while limiting the travel time between these two points. To this end, arcs A1-A19 are associated with functions of weight Pa taking into account an overall risk factor XY and an estimated travel time to cross the arc Z.

This function f(XY, Z) is used to determine one or a plurality of routes IT1, IT2. At least one route IT1, IT2 is preferably proposed to the user on a map of the road network so that they are able to directly obtain a general view of at least one proposed route IT1, IT2.

Preferably, determining at least one route IT1, IT2 is performed by a processor integrated into a smartphone or an on-board computer. Thus, the method for determining at least one route IT1, IT2 of the invention may be integrated into a smartphone application or into a module of an on-board computer of a motor vehicle.

In the example of the invention, the pollutants considered correspond to those conventionally present on any road network and are preferably divided into three categories: airborne pollutants, solar pollutants and noise pollutants. The solar pollutants correspond to the quantity of ultraviolet radiation that the user is subjected to if they take the arc considered, whereas the noise pollutants correspond to the quantity of decibels which the user is subjected to if they move along arc A1-A19.

The airborne pollutants include, for example, nitrogen dioxide NO2, sulphur dioxide SO₂, ozone O₃, the quantity of pollen estimated on the arc being considered and the quantity of fine particles PM 2.5 and PM 10. In the context of the invention, at least two different pollutants are considered on all of the arcs A1-A19 to determine the route.

Apart from the example of the road network, the pollutants considered may correspond to visual pollutants, such as the presence of black clouds which, correlated with areas of high turbulence, make it possible to determine an aircraft route by limiting the passages in areas of high turbulence and in areas of reduced visibility.

In the example of an order preparation warehouse, it may be desired to prepare products that are sensitive to bacteria, such as meat, without passing into areas with a high risk of contamination or with excessive heat. Thus, in this example of order preparation, the pollutants may correspond to heat and the presence of potentially contaminating airflows.

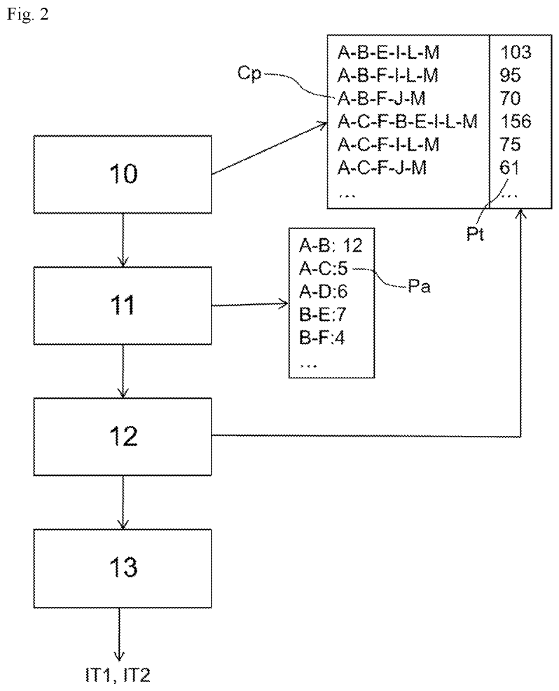

To return to the example of the road network, at least one route IT1, IT2 may be determined by searching for at least one path, among the different possible paths, having a minimum total weight Pt, as illustrated in FIG. 2.

To this end, a first step 10 consists in listing the set of possible paths Cp between the two points considered A and M by using one or a plurality of the arcs A1-A19 placed between the two points. This set of possible paths Cp is preferably stored in a chart.

In a second step 11, the weight Pa of each arc A1-A19 used in the various possible paths Cp is calculated. A third step 12 aims to complete the chart created in step 10 by calculating a total weight Pt of each possible path Cp by calculating the sum of the weights Pa of arcs A1-A19 of each possible path Cp.

Thus, step 13 may determine at least one route IT1, IT2 by searching for at least one path among the possible paths Cp having a minimum total weight Pt. This algorithm may, for example, be implemented in the form of the Dijkstra algorithm.

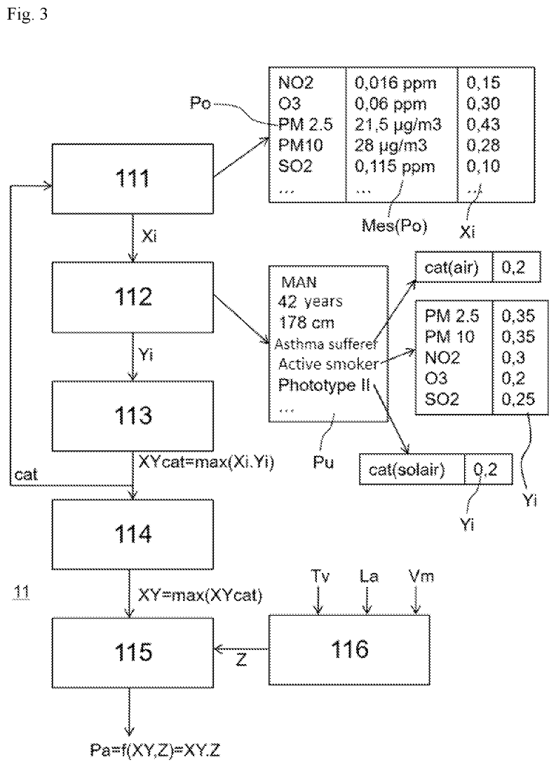

The invention resides more particularly in step 11 for calculating the weight Pa of each arc A1-A19. As illustrated in FIG. 3, in the example of a road network and a user seeking to limit airborne, solar or noise pollutants which they are subjected to, step 11 comprises a first substep 111 for obtaining environmental quality indicators Xi for each arc A1-A19 and for each pollutant considered.

Preferably, this first substep 111 aims to obtain only the environmental quality indicators Xi of a single pollutant category cat. In the example of FIG. 3, the airborne pollutant category is illustrated with reference to this substep 111. Thus, for each arc A1-A19, the measurements Mes(Po) are obtained from the various airborne pollutants present on this arc. Such measurements may be made by means of air quality sensors or be estimated on the basis of meteorological data, such as wind strength and direction, and sensors remote from the area of the arc considered.

Preferably, the measurements Mes(Po) correspond to the quantity of pollutants which a user is subjected to when they cross the arc considered.

Clearly, the measurements of the various pollutants are very heterogeneous and it is not possible to compare these measurements with one another to determine which ones generate a greater or lesser weight of each arc A1-A19.

To this end, the invention proposes to standardise the measurements Mes(Po) of each pollutant on each arc A1-A19 by using a reference risk scale.

For example, nitrogen dioxide NO₂ may be considered to have no health impact if there are measured concentrations of less than 0.01 ppm. In contrast, a major impact on health may be estimated if the NO₂ concentration measured is greater than 0.05 ppm. Between these two extreme values, a large number of measurements may be obtained and must be assessed.

In this example, the reference risk scale may relay data standardised between 0 and 1 with a value of zero when the measured value of nitrogen dioxide NO₂ is less than or equal to 0.01 ppm and a value of 1 when the measured nitrogen dioxide NO₂ value is greater than or equal to 0.05 ppm. A linear scale is then constructed between these two extreme values so as to obtain a value of between 0 and 1 for each measurement of between 0.01 ppm and 0.05 ppm of nitrogen dioxide NO₂.

This standardisation strategy is performed for each pollutant and for each Mes(Po) measurement of each arc A1-A19 so as to obtain a chart of the environmental quality indicators Xi in each category considered for each arc A1-A19.

However, it is insufficient to know these standardised indices Xi to be able to take into account the specific sensitivities of a user. To this end, a second substep 112 proposes to determine risk factors Yi associated with each pollutant for a specific user. To this end, the user may complete a personalised profile by entering information on their sex, age, height, physiological characteristics and health concerns or habits which may influence any sensitivities to pollutants they may have.

For example, a person with asthma has a high sensitivity to all airborne pollutants, and a person with a phototype II has a high sensitivity to ultraviolet radiation. Thus, a user may exhibit sensitivities to all of the pollutants in a certain category or an exacerbated sensitivity to one or a plurality of specific pollutants of a certain category. For example, if the user indicates that they are an active smoker, certain pollutants in the airborne pollutant category may have a greater or lesser impact on the health of the user. According to physiological studies conducted on a range of individuals, typically, active smokers are more sensitive to PM 2.5 fine particles than to NO₂ nitrogen dioxide. By using the results of these physiological studies, it is possible to prepare a chart of relationships between a user profile and risk factors Yi.

At the end of this substep 112, a specific user has risk factors Yi which may correspond to the entire pollutant category and/or to certain specific pollutants in a certain category. By using the environmental quality indicators Xi and the risk factors Yi, the substep 113 can calculate the categorical risk factors XYcat. In this substep 113, each environmental quality indicator Xi is multiplied with each risk factor Yi associated with the user and the maximum of these products reveals the categorical risk factor XYcat. When this categorical risk factor Xycat has been determined for a first category cat, the method can return to the substep 111 by modifying the category considered to reproduce the steps 111, 112 and 113 for a second category, and so on so as to scan all the categories considered. At the end of this loop, a plurality of categorical risk factors XYcat were determined for each arc A1-A19 and the substep 114 makes it possible calculate the overall XY risk factor corresponding to the maximum of the XYcat categorical risk factors.

In a variant, it is possible to consider a single category cat and directly obtain the overall risk factor XY at the end of the first substep 112.

Finally, it is necessary to take into account the estimated travel time to cross each arc Z to determine the weight Pa of each arc A1-A19. To this end, a substep 116 proposes estimating this travel time Z according to a selected transport type Tv, a length of the arc La, and an average speed Vm associated with the selected means of transport. Thus, if the user indicates that they wish to travel on foot between the two points A and M, an average speed of 5 km/h may be considered, whereas if the user indicates that they wish to travel by car, the average traffic of each arc may be estimated to take account of any disruptions throughout the road network. These modifications of the weight Pa of each arc A1-A19 according to any disruptions throughout the road network are already known and may be used in combination with any modifications to the weights Pa of the invention.

At the end of this substep 115, the weight Pa of each arc A1-A19 is determined by multiplying the overall risk factor XY with the estimated travel time to cross the considered arc Z.

As illustrated in FIG. 2, this weight may then be used to calculate the total weight and provide a route to the user according to their customised environmental specifications and sensitivities.

It is also possible to propose a plurality of routes simultaneously to the user. For example, it is possible to determine which pollutant category predominates over each arc and to estimate the category predominant over all the A1-A19 arcs in the first route proposed. A second route may then be calculated by removing this predominant pollutant category to propose a faster route to the user if they choose to be subjected to a degree of noise indicated.

For example, if the user wishes to travel on foot in the town or city between two points at a busy time, it may be estimated that the noise pollution is very high on most of the arcs A1-A19 proposed, so that the route calculated may be much longer than the fastest route.

A second route may be proposed without taking into account the noise pollution category so that the user may consciously choose a faster route but with a higher degree of noise pollution.

Similarly, to meet the objectives of limiting the pollutants which the user is subjected to, the application may calculate a plurality of routes at deferred times so as to propose a deferred departure if this departure makes it possible to limit the pollutants which the user is subjected to and/or to reduce their travel time.

The invention thus makes it possible to propose one or a plurality of routes to a user according to their particular sensitivities, while limiting the travel time between two points.

1. A method for determining at least one route between at least two points of a point cloud interconnected by arcs, said method comprising the following steps:
identifying a set of possible paths between said at least two points by using one or a plurality of said arcs placed between said at least two points;
calculating a weight of each arc used in said possible paths;
calculating a total weight of each possible path by performing the sum of said weights of said arcs of said possible path; and
determining at least one route between said at least two points by searching for at least one path among said possible paths having a minimum total weight;
characterized in that said calculation of said weight of each arc is obtained by thee following steps:
obtaining a plurality of environmental quality indicators of said arc for a plurality of different pollutants; each environmental quality indicator being calculated on the basis of an estimate of each pollutant on said arc standardized by using a reference risk scale;
determining at least one risk factor associated with each pollutant for a specific user;
calculating an overall risk factor corresponding to the maximum of one product between each environmental quality indicator and each risk factor; and
calculating said weight of each arc by multiplying an estimated travel time to cross said arc by using said overall risk factor calculated for said arc.

2. The method for determining at least one route according to claim 1, wherein the determination of at least one risk factor associated with each pollutant for a specific user is obtained according to a user profile and predetermined risk factors associated with each characteristic of said user profile.

3. The method for determining at least one route according to claims 1, wherein the pollutants considered belong to different categories of environmental pollutants; said step for calculating an overall risk factor being performed by calculating the maximum of a plurality of categorical risk factors; each categorical risk factor corresponding to a maximum of a product between each environmental quality indicator and each risk factor of an environmental pollutant category.

4. The method for determining at least one route according to claim 3, wherein the environmental pollutant categories correspond to airborne pollutants, solar pollutants, noise pollutants, electromagnetic pollutants and/or health pollutants.

5. The method for determining at least one route according to claim 4, wherein the airborne pollutants considered include nitrogen dioxide, sulphur dioxide, ozone, carbon monoxide, pollen and/or fine particles.

6. The method for determining at least one route according to claim 3, wherein said method is configured to detect, for each weight, said environmental pollutant category corresponding to the maximum of the calculated categorical risk factors, so that said at least one route may be associated with a predominant risk factor category corresponding to said maximum environmental pollutant category for the largest number of arcs of said at least one route.

7. The method for determining at least one route according to claim 6, wherein said method is configured to determine two routes:
a first route associated with a predominant risk factor category; and
a second route calculated without taking into account said predominant risk factor category in said weights of each arc.

8. The method for determining at least one route according to claim 1, wherein said method is configured to calculate one or a plurality of routes at subsequent times and, if one of the subsequent routes has an improvement in the travel time that is greater than a threshold value, to propose two routes:
a first route with an immediate departure; and
a second route with a delayed departure; said second route corresponding to the subsequent route having the greatest improvement in the travel time.

9. The method for determining at least one route according to claim 1, wherein said travel time to cross said arc is estimated according to a type of a selected transport mechanism, a length of said arc and an average speed of said selected transport mechanism.

10. A smartphone application implementing a method for determining at least one route according to claim 1.
